(19) United States
(12) Patent Application Publication
(10) Pub. No.: US 2013/0341993 A1
(43) Pub. Date: Dec. 26, 2013

(54) BUCKLE POSITIONING DEVICE, AND SYSTEMS, KITS, AND METHODS RELATING THERETO

(71) Applicants: Kacey K. Kennington, Hurricane, UT (US); Nicholas R. Lauritzen, Hurricane, UT (US)

(72) Inventors: Kacey K. Kennington, Hurricane, UT (US); Nicholas R. Lauritzen, Hurricane, UT (US)

(21) Appl. No.: 13/926,967

(22) Filed: Jun. 25, 2013

Related U.S. Application Data
(60) Provisional application No. 61/664,028, filed on Jun. 25, 2012.
(60) Provisional application No. 61/693,708, filed on Aug. 27, 2012.

(51) Int. Cl. B60R 22/10

(52) U.S. Cl. CPC B60R 22/105
USPC 297/464

(57) ABSTRACT

A tool is provided for integrated and/or retrofit installation on a seat having a buckled restraint, to maintain a seat buckle out from under a seated user. The tool may include a positioning element. An example positioning element includes a strap with a loop or other connector at one end. The loop or other connector may connect directly or indirectly to a seat buckle. A second end of the strap or other buckle positioning may connect to the seat, or to environment associated therewith. The strap or other positioning element may pull the buckle forward. When the buckle is detached from the restraint system, the buckle remains forward rather than falling backward onto the seat where it can be sat upon. The positioning element may stretch when the buckle system is engaged. The working length of the positioning element may be adjustable to allow use with various seating systems.

### CROSS-REFERENCE TO RELATED APPLICATIONS

This application claims the benefit of, and priority to, U.S. Patent Application Ser. No. 61/664,028, filed on Jun. 25, 2012 and titled “BUCKLE POSITIONING DEVICE, AND SYSTEMS, KITS AND METHODS RELATING THERETO,” and to U.S. Patent Application Ser. No. 61/693,708, filed on Aug. 27, 2012 and titled “BUCKLE POSITIONING DEVICE, AND SYSTEMS, KITS AND METHODS RELATING THERETO.” The above applications are expressly incorporated herein by this reference in their entireties.

### TECHNICAL FIELD

The present disclosure relates generally to seats and restraint systems on seats. More particularly, aspects of the present disclosure relate to positioning of a seat buckle device. More particularly still, devices, systems, kits, and methods of the present disclosure relate to maintaining a seat buckle of car seats and other structures in a forward position rather than a rearward position which can be sat upon.

### RELATED ART

Car seats are now used almost universally for infants, toddlers, and young children. Typically, a car seat for a child is a portable device that can be moved from vehicle to vehicle. The car seat can then be held in place using a seat belt, using strap and hook combinations that attach to anchors in the vehicle, or in other manners. When held in place, car seats provide a transportation device that increases safety for children in the event of collision, abrupt stop, or other accident or condition.

A car seat may have any number of different types of restraint systems to secure the child to the car seat. An example car seat may include a so-called five point harness system. A five point harness is designed to divert forces away from a child using five points of contact with the car seat. Such a system may also be designed to make contact with a child and transfer collision forces to the strongest parts of the child's body. For instance, the five point harness may contact the child's hips and shoulders.

In a five point harness system, the car seat may include two shoulder straps that each extend over the shoulders and chest of the child. Between the child's legs there may be a buckle. Each shoulder strap includes an attachment element to attach to the buckle. With the shoulder strap attached at the buckle, a bottom portion of the shoulder strap may extend across the child's lap. Optionally, a second buckle may attach to the upper regions of each shoulder strap. When the child is in the car seat, the second buckle components can attach to connect the shoulder straps across the child's chest.

The lower buckle of a five point harness is typically connected to the bottom or seat portion of the car seat. Generally, the buckle attaches to a strap that allows the buckle to be moved. When the child is outside of the seat, the buckle and strap typically are positioned on the seat itself. Thereafter, when a child sits on the car seat, the child will often sit directly on top of the strap and buckle. This may make it difficult for the child or an adult helping buckle the child to find the buckle. Sitting on the car seat buckle, and then subsequently having to find and then remove the buckle from under the child can increase the length of time needed to buckle the child. In addition, when the car seat sits in a hot car, the buckle can increase in temperature. When the child sits on a hot buckle, the child may burn himself or herself. The likelihood of the buckle falling onto the seat and being sat upon increases for many car seats which are inclined downward from the front the back of the car seat.

### SUMMARY

The present disclosure relates to systems, devices, kits and methods for positioning a buckle of a car seat. More particularly, the present disclosure relates to maintaining the buckle in a forward position where it can be easily located and which is difficult for a child to sit on. An example device may include a strap and a loop. The loop may be configured to fit around the buckle of the car seat. The strap may be configured to attach to the front or bottom of the car seat. A length of the strap may be such that when the child is not in the car seat the strap pulls the buckle forward. Optionally, the strap includes a resilient member. The resilient member may be stretched when the child is in the car seat to allow the buckle to be positioned in a more rearward position and attached to the attachments of the shoulder straps. Upon release of the buckle, the resilient member may contract and pull the buckle forward.

In a more specific embodiment, a buckle positioning device may include an attachment feature for attaching a restraining strap to a car seat. The attachment feature may include a buckle, clip, clasp, adhesive, mechanical fastener, other fastener, or some combination of the foregoing. According to one embodiment, the attachment feature may be selectively removable or repositionable. Optionally, the attachment feature and/or strap is adjustable. For instance, a user may connect the attachment feature to the car seat and extend the strap between the attachment feature and the seat buckle. The user may adjust the length of the strap (or the location of the attachment feature) to ensure that the strap maintains the buckle in a forward position when not buckled. In some embodiments, the strap and/or attachment feature may be integrally formed with the car seat.

More generally, a car seat system of the present disclosure may include a car seat with a seat buckle, and a resilient member connected to the buckle. The buckle may be configured to connect to one or more buckle members attached to one or more shoulder straps. When the buckle members are detached from the seat buckle, the resilient member may pull the buckle forward. The resilient member may apply a biasing force that can be overcome by a user to allow attachment to the buckle members, which allow positioning in a rearward position.

In another embodiment, a kit is provided for retrofitting existing car seats. The kit includes a positioning member and an attachment member. The attachment member can attach to the car seat or portion of a vehicle. The positioning member can attach to or near the seat buckle. The positioning member may be resilient or otherwise biased to position the seat buckle forward in an equilibrium position. The kit may include the positioning member detached from the attachment member or attached thereto. The positioning member may therefore be selectively attached and/or adjusted relative to the attachment member.

In another aspect, a method is disclosed for positioning a car seat buckle. A car seat may have forward and rear sides. A seat buckle at or near the forward side may be attached to a strap. The seat buckle and/or strap can be connected to a resilient element. The resilient element may extent towards, and optionally past, the forward side of the car seat. A force exerted by the resilient element can cause the seat buckle to be pulled towards the forward side of the car seat. Optionally, a clip or other attachment member can be used to secure the resilient element in place. One end of the resilient element may attach to the seat buckle while an opposing end attaches to the attachment member.

Other aspects, as well as the features and advantages of various aspects, of the present invention will become apparent to those of ordinary skill in the art through consideration of the ensuing description, the accompanying drawings and the appended claims.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 is a perspective view of a five point harness car seat having a seat buckle in a rearward position, in accordance with one embodiment of the present disclosure;

FIG. 2 is a side view of the seat buckle of the car seat of FIG. 1, with a body of the car seat illustrated in outline, in accordance with one embodiment of the present disclosure;

FIG. 3 is a perspective view of an example buckle positioning device according to one embodiment of the present disclosure, the device including a positioning member and an attachment member, in accordance with one embodiment of the present disclosure;

FIG. 4A is a cross-sectional side view of the buckle positioning device of FIG. 3, with the attachment member shown to be secured to the attachment member, in accordance with one embodiment of the present disclosure;

FIG. 4B is a cross-sectional side view of a buckle positioning device similar to that of FIG. 3, in accordance with one embodiment of the present disclosure;

FIG. 5 is a perspective view of the five point harness car seat of FIG. 1, the seat buckle being in a forward position due to a buckle positioning device similar to that of FIG. 3, in accordance with one embodiment of the present disclosure;

FIG. 6 is a side view of the seat buckle of the car seat of FIG. 5, with a body of the car seat illustrated in outline, in accordance with one embodiment of the present disclosure;

FIG. 7 is a side view of another seat buckle positioning system of the car seat of FIG. 5, in accordance with one embodiment of the present disclosure;

FIG. 8 illustrates a side view of an example of a buckle positioning kit including a positioning member with a strap, and an attachment member with a clip that is detachable from the strap, in accordance with one embodiment of the present disclosure;

FIG. 9 illustrates a side view of the buckle positioning kit of FIG. 8, with the attachment member connected to the positioning member, in accordance with one embodiment of the present disclosure;

FIG. 10 illustrates a side view of the example attachment member of FIG. 9, in accordance with one embodiment of the present disclosure;

FIG. 11 is a side view of another seat buckle and car seat, with the body of the car seat illustrated in outline, and the kit of FIGS. 8 and 9 being attached to the seat buckle and car set, in accordance with one embodiment of the present disclosure;

FIG. 12 is an enlarged side view of a portion of the car seat and seat buckle of FIG. 11, specifically illustrating a manner for attaching the kit of FIGS. 8 and 9 to the car seat, in accordance with one embodiment of the present disclosure;

FIG. 13 is a side view of another seat buckle and car seat, with the body of the car seat illustrated in outline, and a retraction mechanism allowing the seat buckle to be in an extended, use position, in accordance with one embodiment of the present disclosure; and

FIG. 14 illustrates a side view of the seat buckle and car seat of FIG. 13, the seat buckle now being in a retracted, storage position, in accordance with one embodiment of the present disclosure.

### DETAILED DESCRIPTION

Aspects of the present disclosure generally relate to car seats, and more particularly to car seats that can be installed in a moving vehicle for use by children or other people. More particularly, aspects of the present disclosure relate to positioning devices for maintaining a car seat buckle in a forward position where the buckle is less likely to be sat upon by a child or other person using the car seat. As a result, the person sitting in the car seat, or someone assisting the person sitting in the car seat, can more easily find and access the buckle to secure the person in the car seat.

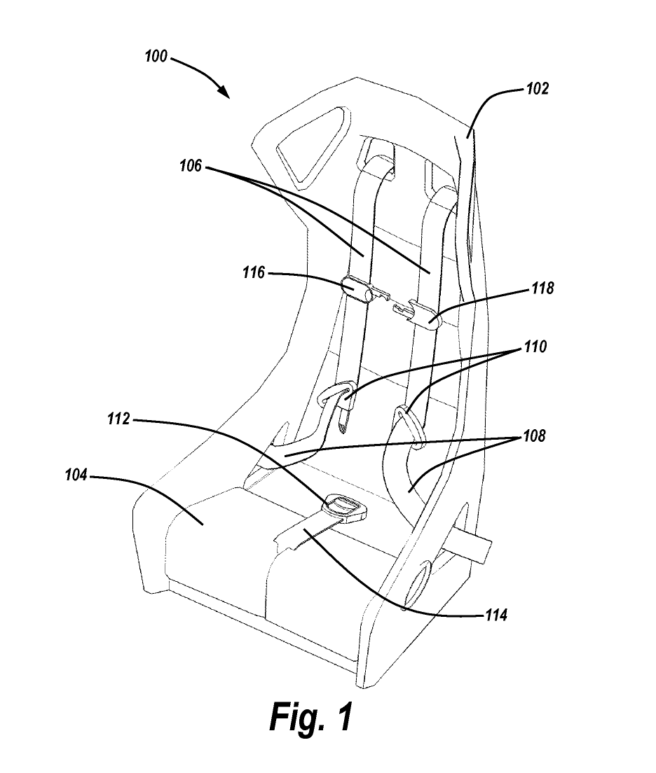

FIG. 1 generally illustrates an example car seat system 100 which can be used on connection with embodiments of the present disclosure. In particular, the car seat system 100 of FIG. 1 includes a car seat body 102 and a seat 104. Included within the car seat body 102 is a set of shoulder straps 106. The shoulder straps 106 may be configured to fit over the shoulders and/or chest of a person within the car seat. The shoulder straps 106 may also connect to, or be integrally formed with lap straps 108. The lap straps 108 may be configured to fit across the lap of a person on the seat 104. In particular, the lap straps 108 may contact the hips of the person.

In one embodiment, each shoulder strap 106 transitions into, or connects to, a lap strap 108 at or near a buckle attachment member 110. The buckle attachment member 110 may be configured to attach to a seat buckle 112. The seat buckle 112 may be connected to the seat 104, and potentially can extend therefrom. In this embodiment, the seat buckle 112 is optionally connected to a strap 114. The strap 114 may be connected to the seat 104 and can allow the seat buckle 112 some movement (e.g., up, down, left right, forward, backward, etc.). When a person is placed on the seat 104, the strap 114 may extend between the person's legs. The seat buckle 112 may then attach to the attachment members 110 (which are optionally also part of a buckle system). The shoulder straps 106 may extend up on the chest and over the shoulders of the person on the seat 104, while the lap straps 108 may extend over the hips of the person.

Optionally, a second buckle may be included. In this embodiment, for instance, buckle portions 116, 118 may be connected to respective shoulder straps 106. When the person is in the car seat 100, the buckle portions 116, 118 can be connected together to form a second buckle. The second buckle may be positioned across the chest of the person and can connect the two shoulder straps 106 together to hold the person more securely into the car seat 100.

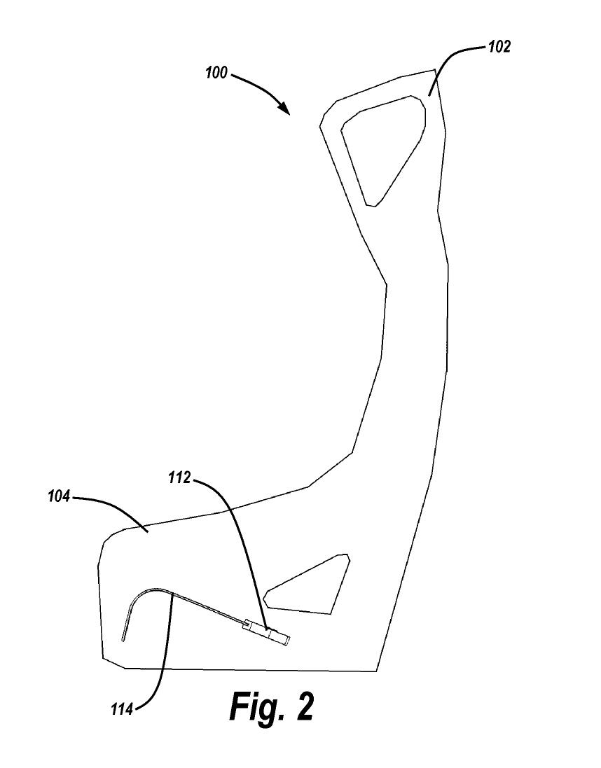

FIG. 2 illustrates the car seat 100 of FIG. 1 in profile, with the strap 114 and seat buckle 112 more clearly illustrated. When the buckle 112 is not connected to the attachment members 110, the buckle 112 can fall towards a rear or back side of the seat 104 and/or car seat body 102. In this position, a person could enter the car seat 100 and sit on the seat 104 and buckle 112, making it difficult to attach the attachment members 110 (see FIG. 1) without first lifting or removing the person to find and reorient the buckle 112.

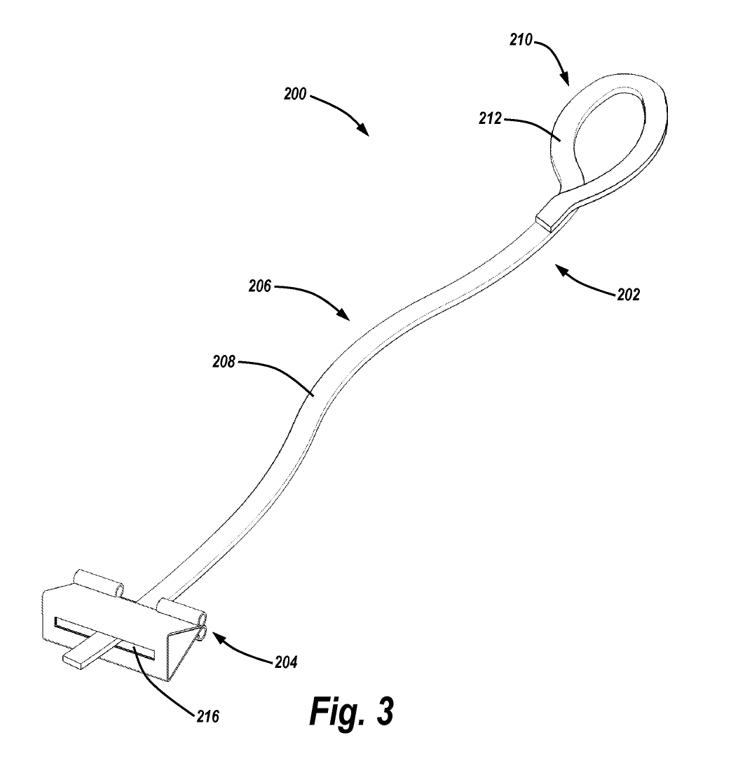

FIG. 3 illustrates an example buckle positioning device 200 that may be used in connection with a car seat (e.g., car seat system 100 of FIGS. 1 and 2). In this embodiment, the buckle positioning device 200 includes a positioning member 202 and an attachment member 204. The positioning member 202 may be used to position the seat buckle of a car seat while the attachment member 204 may be used to attach the buckle positioning device 200 to a car seat. In some embodiments, the attachment member 204 connects to one position of a car seat (e.g., a seat, a body, etc.) or to a portion of a car (e.g., a seat belt, bench seat, etc.) while the positioning member 202 connects to a different portion of the car seat (e.g., to a seat buckle or strap associated with a seat buckle). While the attachment member 204 and positioning member 202 are illustrated as being connected, they are optionally selectively removable. In one embodiment, a kit may be provided and can include the positioning member 202 and attachment member 204 in either a detached or connected state.

The positioning member 202 of the buckle positioning device 200 may have any number of suitable forms. In one embodiment, for instance, the positioning member 202 may include a strap 206. The strap 206 is optionally made of a flexible and/or resilient material. For instance, the strap 206 may be made of a material having elastic properties so as to expand in response to a tensile force, and to contract when the tensile force is removed or reduced. In addition to, or instead of, the strap 206, a cord, band, tether, set of linkages, or other component, or any combination of the foregoing, may also be used. For convenience, such components are collectively referred to herein as “straps”.

In the illustrated embodiment, the strap 206 is shown as having at least two portions. The at least two portions may include an elongated portion 208 and an attachment portion 210. The attachment portion 210 is shown as a loop 212 in this embodiment. The loop 212 may be formed by looping a distal end of the strap 206. One embodiment may include securing the distal end of the strap 206 to a medial portion of the strap 206 to form the loop 212 between connected distal and medial portions. Any securement method, including sewing, bonding, adhesives, heating, melting, welding, or other method may be used to attach the portions of the strap 206 to form the loop 212. In other embodiments, rather than, or in addition to, a loop 212, a slit, slot, clip, clasp, or other element, or any combination of the foregoing may be used. The types of components or structures included as part of the attachment portion 210 may therefore be varied, but in one embodiment may be suitable for attaching to a seat buckle of a car seat, either directly or indirectly (e.g., to a strap associated with the seat buckle).

The illustrated elongated portion 208 is shown in this embodiment as extending from the loop 212 to the proximal end of the strap 206. The elongated portion 208 may be sized and configured to generally extend from the attachment member 204, and have sufficient length so as to allow the loop 212 to attach to a seat buckle when the attachment member 204 is secured in place on or near the car seat.

The illustrated attachment member 204 is shown as being a clip, although any suitable component may be used. In one embodiment, the attachment member 204 is configured to attach to or near a car seat. For instance, the attachment member 204 may attach to a base or body portion of a car seat. Where the attachment member 204 is a clip, for instance, the clip may have open and closed configurations. The closed configuration is optionally an equilibrium condition and a force may be required to open the clip to the open position. Once in the open position (which may actually be a series of different open positions), a portion of the car seat can be inserted between opposing ends of the clip. Upon releasing the force on the clip, the ends may return towards the equilibrium position and can grasp a portion of the car seat therebetween. Thus, the clip may then be in an attached position and secured in place using frictional engagement.

The clip or other attachment member 204 can operate in any suitable manner or attach to any suitable component. For instance, rather than attaching to a portion of the car seat (e.g., the body, the seat, etc.), the attachment member 204 may instead attach to a bench seat, seat belt, or other component of a vehicle. Moreover, while the attachment member 204 is shown as a clip that may be selectively attached, detached, repositioned, etc., the attachment member 204 may be more permanent. For instance, the attachment member 204 may instead be integrally formed within a car seat system 100 (see FIG. 1).

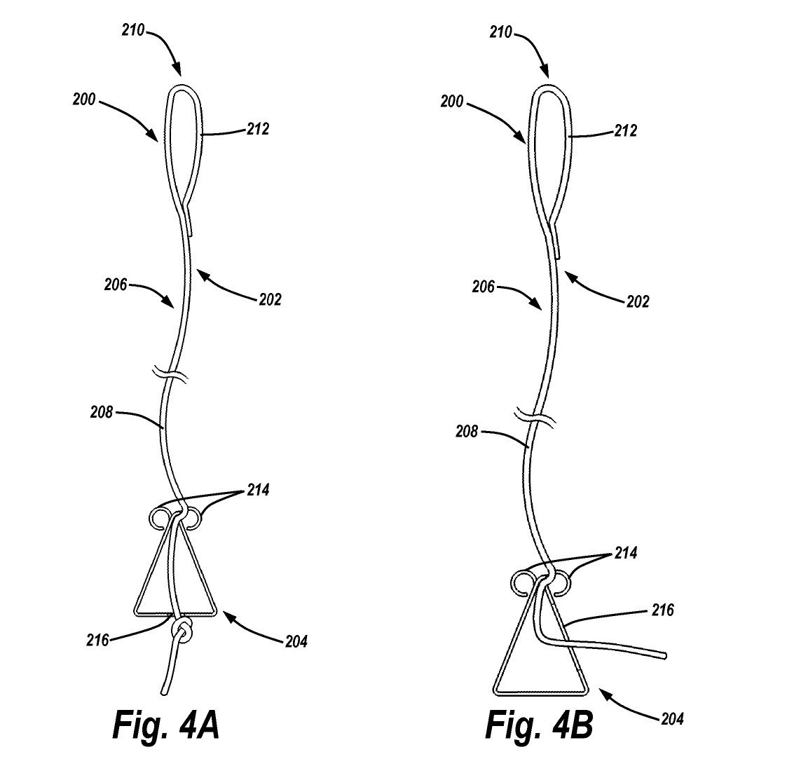

The positioning member 202 is optionally adjustable relative to the clip or other attachment member 204. FIG. 4A provides an example in which the elongated portion 208 may be adjustable relative to the clip or other component of the attachment member 204.

More particularly, the clip of the illustrated embodiment may include opposing engaging elements 214. The clip may have an equilibrium position in which the engaging elements 214 are biased towards each other, and possibly biased to remain in contact. If a force is applied to separate the engaging elements 214, they may move laterally apart to create an opening therebetween. A car seat, seat belt, or other component may be inserted between the engaging elements 214, and then secured thereto when the engaging elements 214 retract towards the closed position to frictionally engage the car seat, seat belt, or other component.

The elongated member 208 may also be positioned between the engaging elements 214. Thus, when the clip closes, the elongated member 208 may also be secured between elements 214. In such an embodiment, the elongated member 208 may therefore engage one or both engaging elements 214 and/or a car seat or other component to which the clip is secured.

As also shown in FIGS. 4A and 4B, the clip or other component of the attachment element 204 optionally defines an opening 216. The proximal end of the strap 206 or other elongated member 208 may pass through the opening 216. Thereafter, the user may adjust an effective length of the strap 206. For instance, by pulling on the proximal end, the user can reduce the length between the attachment element 204 and the loop 212. Alternatively, by holding the clip, or securing the clip in place, and pulling on the loop 212, the length can be increased. When the clip is closed, the strap 206 may be held in place with sufficient force to maintain the strap 206 at approximately a constant effective length; however, with sufficient additional force a user can overcome the frictional forces of the strap 206 binding on itself, the clip and the car seat or the like, to increase or decrease the length.

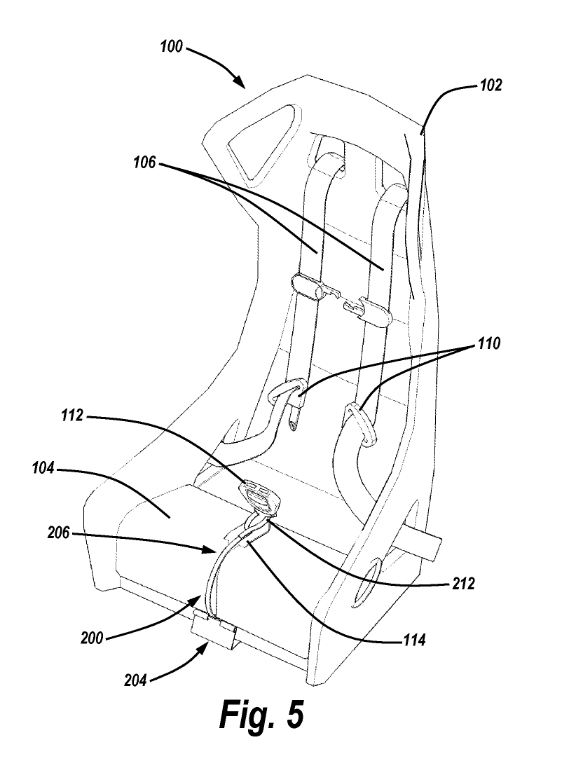

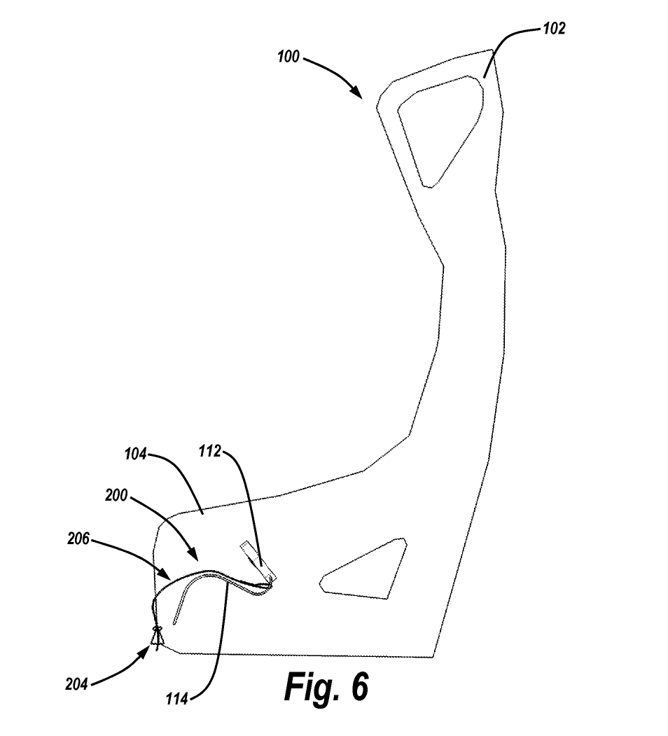

A particular manner in which the buckle positioning device 200 can be used is shown in FIGS. 5 and 6. FIG. 5, for instance, illustrates a car seat system 100 similar to that illustrated in FIG. 1. In this embodiment, the buckle positioning device 200 may be attached to the car seat system 100 at one or more positions. For instance, an attachment member 204 may be attached to a base or other portion of the body 102 of the car seat system 100. Such attachment may include, for instance, opening a clip and frictionally securing the clip to a portion of the car seat system 100. In other embodiments, however, an attachment member 204 may include something other than a clip, may be integrally formed with the car seat 100, may attach to something other than the car seat system 100, or be used in another, alternative manner.

As also shown in FIG. 5, a loop 212 or other component of a positioning member may be attached directly or indirectly to the seat buckle 112. In this embodiment, the loop 212 may be looped around and over the seat buckle 112 and placed around the strap 114, which is in turn attached to the buckle 112. The length of the strap 206 or other portion of the buckle positioning device 200 may be adjusted before or after securement of the clip or loop 212. In some embodiments, such as that illustrated in FIG. 5, the length may be sufficient so as to cause the seat buckle 112 and/or the strap 114 to be pulled forward, such that the seat buckle 112 does not fall towards the rear of the car seat system 100.

FIG. 6 illustrates another view of the buckle positioning device 200 of FIG. 5. In particular, the car seat system 100 is shown in outline and the buckle 112 and buckle positioning device 200 are shown in additional detail. In this embodiment, the optional strap 206 of the buckle positioning device 200 may extend forward relative to the seat buckle 112. A clip or other attachment member 204 may be placed at or near the front side of the car seat system 100, and allow the strap 206 to extend upwardly and/or rearwardly toward the seat buckle 112. A tensile force in the strap 206 may pull the seat buckle 112 forward. If, however, a rearwardly directed force is applied to the buckle 112, the user can optionally cause the strap 206 to stretch or otherwise expand, and the buckle 112 can be moved in a rearward direction. Similarly, an upwardly directed force may cause the buckle 112 to move upward while the strap 206 resiliently expands. Of course, combinations of upwardly and rearwardly directed forces may be applied to position the seat buckle 112 as desired for use in securing a person using the car seat system 100. Upon release of the seat buckle 112 from corresponding attachment devices or from a force of a user, the seat buckle 112 may, however, snap or move back to a forward position such as that illustrated, as the strap 206 shortens (e.g., as a resilient strap 206 returns toward an equilibrium length).

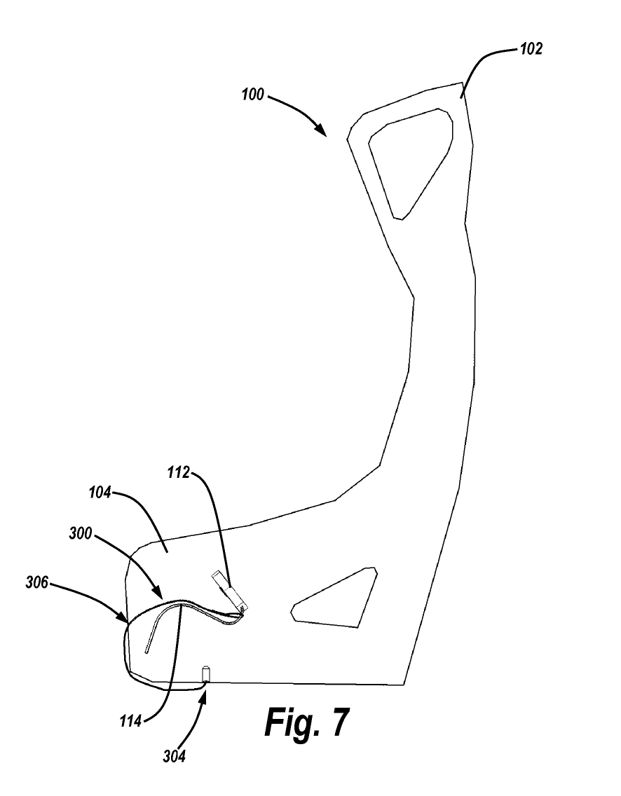

Embodiments disclosed and referenced with respect to FIGS. 1-6 are merely provided for illustration purposes, and are not intended to limit the scope of the present disclosure. For instance, while an attachment member for securing a buckle positioning device is shown as including a clip, such an embodiment is merely illustrative. FIG. 7 illustrates an additional embodiment where a buckle positioning device 300 may include an attachment member 304 that may replace or supplement a clip. In this particular embodiment, the car seat body 102 may have an aperture (e.g., opening, hole, slot, etc.) therein. Such an aperture may be pre-formed, and can potentially satisfy some other purpose. As an example, various holes may be formed for use in securing screws or other mechanical fasteners. In other embodiments, the aperture may be formed after-the-fact for after-market use.

The attachment member 304 of the buckle positioning device 300 may include a plug or other similar component. Such a component may be configured to fit wholly or partially within the aperture of the car seat body 102, and optionally be secured in place (e.g., using a mechanical fastener, interference fit, frictional fit, etc.). The plug may attach to a strap 306 which may be similar to other straps or components discussed herein, or otherwise configured to connect to or position a buckle 112 in a forward position. Of course, other styles of attachment devices and members may also be used to connect a buckle positioning device to a car seat or other device with a buckle, or to elements within the environment where the seat is used.

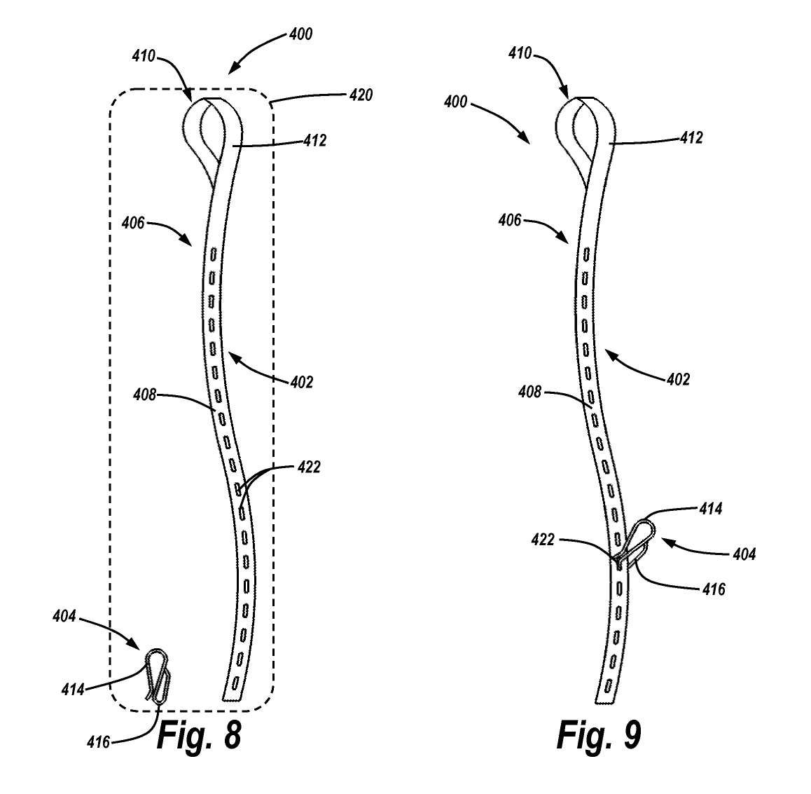

As should be appreciated by a person having ordinary skill in the art in view of the disclosure herein, the embodiments of FIGS. 1-7 are merely illustrative and are not intended to provide an exhaustive view of features and elements of buckle positioning systems, kits, methods and devices, as contemplated herein. For instance, FIGS. 8-12 illustrate yet another example of a buckle positioning kit 400 that may be used in accordance with some embodiments of the present disclosure.

More particularly, FIG. 8 illustrates an example buckle positioning kit 400 that may be used in connection with a car seat (e.g., car seat system 100 of FIGS. 1 and 2). In this embodiment, the buckle positioning kit 400 may include a positioning member 402 and an attachment member 404. The positioning member 402 may be used to position the seat buckle of a car seat while the attachment member 404 may be used to attach the buckle positioning device 400 to a car seat. In some embodiments, the attachment member 404 may connect to one position of a car seat (e.g., a seat, a body, etc.) or to a portion of a car (e.g., a seat belt, bench seat, etc.) while the positioning member 402 connects to a different portion of the car seat (e.g., to a seat buckle or strap associated with a seat buckle).

In this particular embodiment, the attachment member 404 and positioning member 402 are illustrated as being disconnected. In particular, the attachment member 404 and positioning member 402 may be disassembled and part of a kit. A package 420 is schematically illustrated, and may contain or enclose both the attachment member 404 and the positioning member 402. In other embodiments, the attachment member 404 and positioning member 402 may be connected (see, e.g., FIG. 9). If the positioning member 402 and attachment member 404 are connected, the kit 400 may still be enclosed or contained within a package 420 in a connected state. Connected positioning member 402 and attachment member 404 may also be permanently attached, or in other embodiments may be selectively attached to allow for selective disconnection.

The positioning member 402 of the buckle positioning device 400 may have any number of suitable forms. In one embodiment, for instance, the positioning member 402 may include a strap 406. The strap 406 is optionally made of a resilient material. For instance, the strap 406 may be made of a material having elastic properties so as to expand in response to a tensile force, and to contract when the tensile force is removed or reduced. In addition to, or instead of, the strap 406, a cord, band, tether, set of linkages, or other component, or any combination of the foregoing, may also be used.

In the illustrated embodiment, the strap 406 is shown as having at least two portions. The at least two portions may include an elongated portion 408 and an attachment portion 410. The attachment portion 410 is shown as including a loop 412 in this embodiment. The loop 412 may be formed by looping a distal end of the strap 406. One embodiment may include securing the distal end of the strap 406 to a medial portion of the strap 406 to form the loop 412 between connected distal and medial portions. Any securement method, including sewing, bonding, adhesives, heating, melting, welding, connection sleeves or tags, or other method may be used to attach the portions of the strap 406 to form the loop 412. In other embodiments, rather than, or in addition to, a loop 412, a slit, slot, clip, clasp, or other element, or any combination of the foregoing may be used. The types of components or structures included as part of the attachment portion 410 may therefore be varied, but in one embodiment may be suitable for directly or indirectly attaching to a seat buckle of a car seat.

The illustrated elongated portion 408 is shown in this embodiment as extending from the loop 412 to the proximal end of the strap 406. The elongated portion 408 may be sized and configured to generally extend from the attachment member 404, and have sufficient length so as to allow the loop 412 to attach to a seat buckle when the attachment member 404 is secured in place on or near the car seat. In some embodiments, one or more length adjustment features 422 may be included on, or connected to, the strap 406. In particular, the illustrated embodiments shows a series of length adjustment features 422 which may extend along a portion of the elongated portion 408. Such length adjustment features 422 may include any number of structures of components. For instance, the length adjustment features 422 may include slits or openings formed in the strap 406. In other embodiments, the length adjustment features 422 may include snaps, pegs, pins, knots, or other structures, or any combination of the foregoing.

The attachment member 404 may be configured to be used with the length adjustment features 422 to adjust a working length of the strap 406. As shown in FIG. 9, for instance, the attachment member 404 may be connected to one of the length adjustment features 422. In such an embodiment, the length of the strap 406 between the loop 412 and the attachment member 404 may be a working length of the strap 406. As should be appreciated in view of the disclosure herein, if the attachment member 404 is moved to a length adjustment feature 422 nearer the loop 412, the working length of the strap 406 may be reduced. Conversely, if the attachment member 404 is moved to a length adjustment feature 422 further from the loop 412, the working length of the strap 406 may be increased.

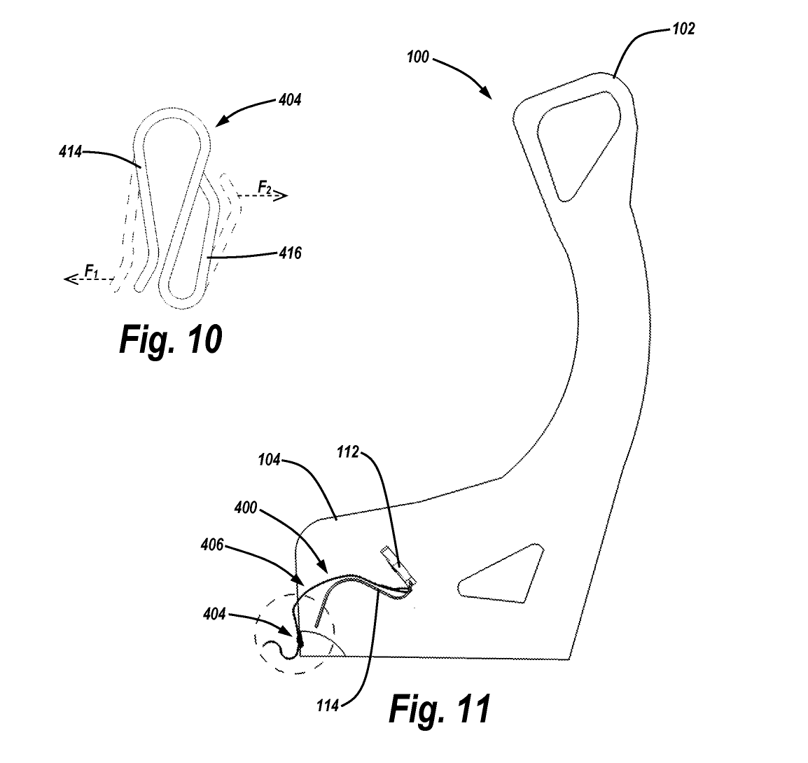

The attachment member 404 illustrated in FIGS. 8 and 9 is shown as a clip, although any suitable component may be used. In one embodiment, the attachment member 404 is configured to attach to or near a car seat. For instance, the attachment member 404 may attach to a base or body portion of a car seat. Where the attachment member 404 is a clip, for instance, the clip may have one or more expanded and/or retracted positions. The retracted or closed position may optionally be an equilibrium condition and a force may be required to open the clip to an expanded or open position. FIG. 10, for instance, illustrates the clip of the attachment member 404 in an equilibrium, retracted or closed position. Various expanded or open states are also shown in phantom lines.

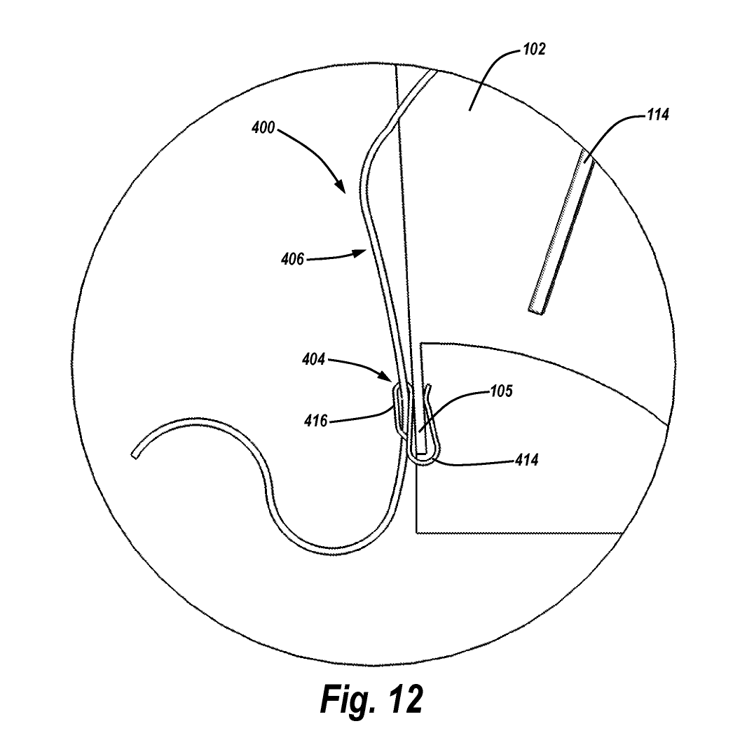

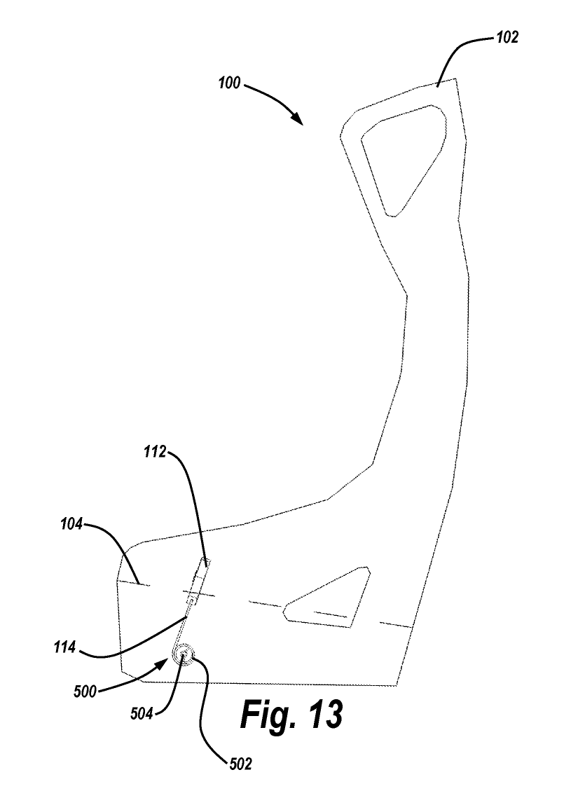

More particularly, the clip of the attachment member 404 in FIG. 10 includes interconnected biased elements 414, 416. More particularly, the first biased element 414 may be biased to the closed position and be configured for use in attaching the attachment member 404 to a body of a car seat, or to some other component associated with a seat. In operation, a force F₁ may be applied as shown in FIG. 10. The force F₁ may have sufficient magnitude to overcome the biasing force holding the first biased element 414 in the retracted, closed position. When such force F₁ is applied, the first biased element 414 may move to the position shown in phantom lines, and can create an opening. That opening may be sufficient to allow attachment to a corresponding structure of a seating element (see, e.g., FIG. 12). The biasing force may also retract the first biased element 414 at least partially to engage the first biased element 414 with the seating element. Thus, the first biased element 414 may also be an engaging element for attaching the first biased element 414 to a car seat, seating element, or other component.

As also shown in FIG. 10, the second biased element 416 may also expand from a retracted position to an expanded position shown in phantom lines. The first biased element 416 may have an internal biasing force that can be overcome by using a force F₂. When the force F₂ is applied, an opening may be created. In some embodiments, this opening may allow a portion of the strap 406 (see FIG. 9) to be positioned within the second biased element 416. For instance, a distal end of the second biased element 416 may be inserted into a slit or opening in the strap 406. Upon releasing the force F₂, the distal end of the second biased element 416 may return to a closed position, with a portion of the strap 406 therein. Thus, the second biased element 416 may also be an engaging element for attaching the second biased element 416 to a positioning member, such as positioning member 402 of FIGS. 8 and 9. FIG. 9 specifically shows an example embodiment in which the second biased element 416 is engaged and secured with the positioning member 402.

As also shown in FIG. 10, the attachment member 404 may include a clip having a generally S-shaped construction which allows opposing ends to be expanded and opened, and thereafter closed with a biasing force. It should be appreciated, however, that such an embodiment is merely illustrative and the clip or other component of the attachment member 404 may have any other suitable construction for being secured to a car seat or other seating element, to a strap 406, to a length adjustment feature, or some other component.

As best shown in FIG. 9, the attachment member 404 may be attached at any number of different locations along the length of the strap 406. As discussed herein, the position of the attachment member 404 may determine a working length of the strap 406. In general, the working length may be a distance between a point of connection to a car seat or seating element (e.g., at the attachment member 404) and the point of connection to a buckle of a seat (e.g., at the loop 412). The working length of the strap 406 may allow the buckle of a car seat to be pulled forward. FIG. 11, for instance, illustrates an embodiment in which the working length of the strap 406 allows the seat buckle 112 of a car seat system 100 to be pulled forward. The strap 406 may be resilient to apply a biasing force pulling the seat buckle 112 forward.

As also shown in FIG. 11, and as better shown in FIG. 12, the attachment member 404 may also connect to the car seat system 100. Once the first biased element 414 is in an open position, it may be slipped around protrusion 105 of the car seat body 105. The protrusion 105 may be sized to fit within an opening created in the first biased element 414 when opened (see FIG. 10). Upon releasing the force on the first biased element 414, the first biased element 414 may return toward an equilibrium position and can grasp a portion of the protrusion 105 therebetween. Thus, the clip may then be in an attached position and secured in place using frictional engagement.

The clip or other attachment member 404 can operate in any suitable manner or attach to any suitable component. For instance, rather than attaching to a portion of the car seat (e.g., the protrusion 105), the attachment member 404 may instead attach to a different element of a car seat (e.g., an opening, slot, etc.), or to a bench seat, seat belt, or other component of a vehicle. Moreover, while the attachment member 404 is shown as a clip that may be selectively attached, detached, repositioned, etc., the attachment member 404 may be more permanent. For instance, the attachment member 404 may instead be integrally formed within a car seat system 100 (see FIG. 1).

As also shown in FIG. 11, the loop 412 or other component of a positioning member 402 may be attached directly or indirectly to the seat buckle 112. In this embodiment, the loop 412 may be looped around and over the seat buckle 112 and placed around the strap 114, which is in turn attached to the buckle 112. The length of the strap 406 or other portion of the buckle positioning device 400 may be adjusted before or after securement of the clip or loop 412. In some embodiments, such as that illustrated in FIG. 11, the length may be sufficient so as to cause the seat buckle 112 and/or the strap 114 to be pulled forward, such that the seat buckle 112 does not fall towards the rear of the car seat system 100.

While buckle positioning devices of the present disclosure have included accessories and attachments that may be used to retrofit an existing seat (e.g., a car seat, etc.). Such devices may also be provided and included by a manufacturer as part of the seat. In other embodiments, a manufacturer may include additional or other features that perform a similar or same function, namely positioning a buckle in a desired position. More particularly, features and buckle positioning systems may position a buckle at a location that makes it difficult or impossible to sit on when the buckle is not connected to corresponding buckle attachment members (e.g., which may be connected to shoulder straps).

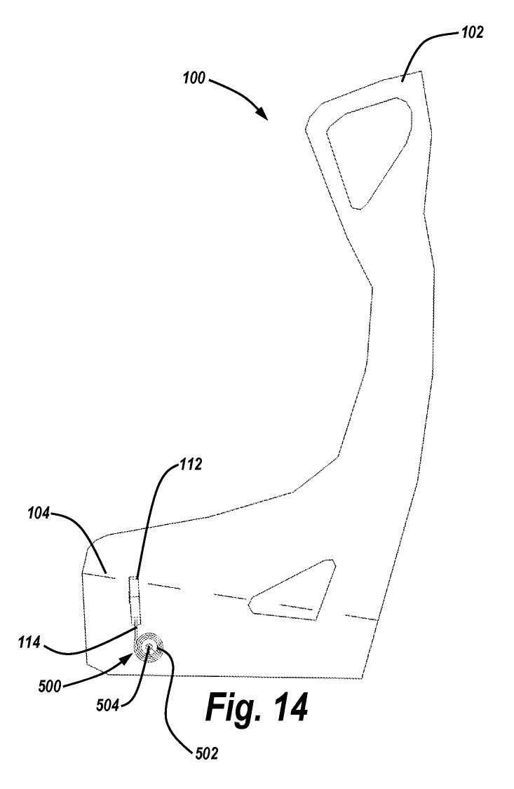

FIG. 13 illustrates an additional embodiment where a seat system 100 may include a seat body 102 and a buckle 112 attached thereto. In this embodiment, the strap 114 attached to the buckle 112 may extend to a buckle positioning system 500. The particular buckle positioning system 500 illustrated in FIG. 13 may include a retractable system allowing the strap 114 to be selectively retracted relative to the seat body 102 and the seat 104 (as well as to a bottom surface of the seat which is illustrated in dashed lines and represents the surface on which a person may sit). The strap 114 may also be selectively extended. When extended, the buckle 112 may be positioned wholly or partially above the bottom surface of the seat 104 so as to be accessible. When accessible, additional buckle elements (e.g., members 110 of FIG. 5) may attach to the buckle. FIG. 13 illustrates the buckle 112 in an accessible, extended, or use position.

In contrast, when the buckle 112 is retracted, the buckle 112 may be wholly or partially inaccessible. As shown in FIG. 14, for instance, the buckle 112 may be retracted to be below the bottom surface of the seat 104 of the seat body 102. The buckle 112 may be wholly below the bottom surface of the seat 104, or only partially therebelow. In any event, when the buckle 112 is wholly or partially retracted, the buckle 112 may be detached from the attachment elements and positioned in a location that is less likely to be sat upon. Consequently, when a person does sit on the seat 100, the buckle 112 may be extended from its storage position that is not under the person.

The buckle positioning system 500 may take any number of suitable forms. FIGS. 13 and 14 illustrate an example that may be used in some embodiments. More particularly, in this embodiment, the buckle positioning system 500 may include a rotating member 502. The rotating member 502 may include or have the form of a wheel, cylinder, or the like, and can be connected to the strap 114 so as to allow the strap 114 to roll therearound. A biasing member 504, such as a torsion spring, may be connected to the rotating member 502. Optionally, the biasing member 504 may be configured to tend to cause the rotating member 502 to rotate in a direction that causes the strap 114 to roll therearound, thereby retracting the strap 114. To expand and extend the buckle 112, a user may pull on the buckle 112 with sufficient force to overcome the biasing force of the biasing member 504. Thus, FIG. 14 may illustrate an example equilibrium position corresponding to a retracted state, while FIG. 13 may illustrate a contrary position in which the biasing force has been overcome to remove the buckle 112 from its equilibrium position.

It should be appreciated in view of the disclosure herein that the example above is merely illustrative. In other embodiments, for instance, the expanded state may be an equilibrium position or there may be multiple equilibrium positions (e.g., at the retracted and extended position). In the same or other embodiments, additional components, including locking pins, release buttons, and the like, may also be provided to facilitate retracting and/or extending the buckle 112.

While the present disclosure describes seating structures as car seats, and further describes five point harnesses within child or other car seats, aspects of the present disclosure may be used with other types of seating and other car seats having buckles. As an example, the illustrated car seats may be used for toddlers; however, other car seats may be used for infants, older children, or even adults. In addition, other devices other than car seats may use devices, systems, and kits of the present disclosure. By way of example, strollers, race cars, go carts, fighter jets, amusement park rides, and other vehicles and devices with restraint systems may make use of the embodiments disclosed herein.

Although the foregoing description contains many specifics, these should not be construed as limiting the scope of the disclosure or of any of the appended claims, but merely as providing information pertinent to some specific embodiments that may fall within the scopes of the disclosure and the invention(s) of the appended claims. Features from different embodiments may be employed in combination. In addition, other embodiments of the present disclosure may also be devised which lie within the scopes of the disclosure and the appended claims. The scope of the present disclosure is, therefore, indicated and limited only by the appended claims and their legal equivalents. All additions, deletions and modifications to example embodiments, as disclosed herein, that fall within the meaning and scopes of the claims, are to be embraced by the claims.

What is claimed is:

1. A buckle positioning device, comprising:
an attachment element configured to attach to a seating element associated with a buckle; and
a buckle positioning element attachable to the attachment element and configured to be secured to the buckle and maintain the buckle in a forward position when the buckle is in a released position.

2. The buckle positioning device recited in claim 1, wherein the attachment element includes a strap.

3. The buckle positioning device recited in claim 1, wherein the attachment element includes a loop.

4. The buckle positioning device recited in claim 1, wherein the attachment element includes a loop connected to a resilient strap, wherein the resilient strap is connected to the attachment element.

5. The buckle positioning device recited in claim 1, wherein the attachment element includes a clip.

6. The buckle positioning device recited in claim 6, wherein the clip includes one or more biasing members for frictionally engaging the seating element associated with the buckle.

7. The buckle positioning device recited in claim 1, wherein the seating element includes a portion of a car seat.

8. The buckle positioning device recited in claim 1, wherein the buckle positioning device is a kit with the attachment element separated from the buckle positioning element.

9. A method for maintaining a seat buckle in a forward position, comprising:
attaching a buckle positioning device to a buckle of a seat; and
attaching the buckle positioning device to a body of the seat, or to an environment in which the seat is located,
wherein the attached buckle positioning device exerts a biasing force causing the buckle to be pulled forward.

10. The method recited in claim 9, wherein the buckle positioning device includes an attachment element including a flexible strap extending between the buckle and either the body of the seat or the environment in which the seat is located.

11. The method recited in claim 9, wherein attaching a buckle positioning device to a buckle of a seat includes securing a loop of the buckle positioning device around the buckle.

12. The method recited in claim 9, wherein attaching the buckle positioning device includes clipping the buckle positioning device to the body of the seat, or to the environment in which the seat is located.

13. The method recited in claim 9, wherein the buckle positioning device includes a flexible, resilient strap exerting the biasing force causing the buckle to be pulled forward.

14. The method recited in claim 9, further comprising:
selectively attaching an attachment element to a buckle positioning element, the attachment element being configured to attach to the body of the seat or to the environment in which the seat is located, and the buckle positioning element being configured to attach to the buckle of the seat.

15. The method recited in claim 9, further comprising:
overcoming the biasing force causing the buckle to be pulled forward, and connecting the buckle to one or more buckle attachment members.

16. The method recited in claim 15, wherein the one or more buckle attachment members maintain the buckle in a position overcoming the biasing force.

17. A seating system, comprising:
a seat;
a buckle associated with the seat for use in securing a person on or in the seat; and
a positioning system configured to maintain the buckle in a desired position when not in use to secure the person in or on the seat.

18. The seating system recited in claim 17, wherein the positioning system includes a resilient strap configured to pull the buckle forward.

19. The seating system recited in claim 17, wherein the positioning system includes a retraction component integral with the seat.

20. The seating system recited in claim 17, the positioning system consisting essentially of a clip and a resilient strap, wherein a working length of the resilient strap is adjustable using the clip.
